(19) United States
(12) Patent Application Publication
(10) Pub. No.: US 2004/0076730 A1
(43) Pub. Date: Apr. 22, 2004

(54) Process for creating milk foam, using aerosol delivery system

(76) Inventor: Jeffrey Fergus Wilkinson, Davis, CA (US)

Correspondence Address: Jeffrey Wilkinson, #136, 1280 Olive Dr., Davis, CA, 95616, US

(21) Appl. No.: 10/687,000

(22) Filed: Oct. 15, 2003

Related U.S. Application Data
(60) Provisional application No. 60/420,108, filed on Oct. 22, 2002.

(51) Int. Cl. C12C 1/00

(52) U.S. Cl. 426/590

(57) ABSTRACT

Herein is disclosed a method for creating milk foam, a common topping for specialty coffee drinks, without steam or heat coagulation. An aerosol delivery system and a protein-rich emulsion form a product that, when dispensed and heated by microwave, is very similar in taste, texture, and appearance to steam-produced milk foam.

### CROSS-REFERENCE TO RELATED APPLICATIONS

This application claims the benefit of Provisional Patent Application Ser. Nr. 60/420,108 filed Oct. 22, 2002.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention described herein relates to milk (cappuccino) foam, as is commonly used as an ingredient of specialty coffee drinks like cappuccinos, and a method for its creation.

During the nineteen eighties and nineties, the United States experienced a tremendous increase in demand for gourmet and specialty coffee drinks. According to the National Coffee Association, nearly 29,000,000 Americans purchased specialty coffee drinks daily in 2002. The number of gourmet coffeehouses has increased exponentially to supply the demand. In most of these coffeehouses, milk foam is one of the most common and popular ingredients.

Milk foam is a component of many specialty coffee drinks (e.g., cappuccinos, lattes). Traditionally, forcing pressurized steam through milk in a metal container has created milk foam. Typically, milk foam has been made with cappuccino machines, which bypass steam used to make espresso through a nozzle device. The user dips the nozzle into a metal container of milk until the agitation and heat from the steam forms milk foam. This milk foam is then mixed and layered on coffee or espresso for the purpose of creating various gourmet coffee drinks.

Inventors have been trying to create devices that allow consumers to enjoy specialty coffees at home. In this connection, they have developed less expensive cappuccino machines, which have a device to create milk foam as demonstrated by U.S. Pat. No. 5,931,080 (1999). Other inventions, as demonstrated by U.S. Pat. No. 6,332,704 (2001) and U.S. Pat. No. 6,283,625 (2001), produce milk foam as their main purpose. These machines, though much less expensive than those available for restaurant use, remain prohibitively expensive for many and lack convenience.

In order to capitalize on the large number of consumers who enjoy specialty coffees, but find them prohibitively expensive (whether at a retail store or made at home with a machine), companies like Nestle Foods and General Mills have developed instant coffee products that claim to foam when stirred. Advertising campaigns costing millions of dollars touted the “Frothe” formed by these products. In truth, these products offer no advantage whatsoever. Not only do they provide little or no foam when stirred vigorously, the products themselves contain small amounts of real coffee and high amounts of sugar and other unhealthy ingredients. Thusly, these instant products do not serve the consumer who prefers real coffee and real dairy milk foam.

### BRIEF SUMMARY OF THE INVENTION

Accordingly, the main objective of this aerosol milk foam method is to allow users to create milk foam in the simplest and most straightforward way possible.

Steam-processed milk foam is protein foam created when heat from steam thrust into a container of milk coagulates milk proteins. This process generally renders less than half of the milk into foam.

By combining certain food ingredients with an aerosol delivery system commonly used for aerosol whipped cream, this aerosol milk foam method produces milk foam very similar to that of steam-processed milk foam traditionally served in coffeehouses. One novel aspect of this aerosol milk foam method is that it incorporates all the milk into foam as compared to steam-processed milk foam, which generally incorporates less than half of the milk. This is accomplished by adding additional protein to the emulsion described as part of this aerosol milk foam method. When additional protein is added to this emulsion, hardier foam is created which binds more liquid thereby utilizing nearly all of the emulsion contained in the aerosol delivery system.

It is important to note that part of the appeal of milk foam, however produced, is the longevity of the foam. In milk foam produced by other than heat coagulation (steam), this longevity can be achieved by two primary methods, the addition of protein and the addition of a stabilizer like carrageenan. Without the addition of protein, too much stabilizer is required and a “gumminess” results. Without the addition of stabilizer, the resulting protein-enriched emulsion results in satisfactory foam, though with somewhat less longevity. In the preferred embodiment, both protein and stabilizer are added which affords nearly five minutes of thick foam after heating.

### DETAILED DESCRIPTION OF THE INVENTION

Traditional milk foam is stabilized by the coagulation of heated milk proteins. The aerosol milk foam method, as described herein, duplicates traditional milk foam by building a protein foam that is stabilized mainly by its high protein content combined with a food stabilizer instead of heat-based coagulation (steam). The preferred embodiment fills an aerosol can with a formula of fat free milk, milk protein such as whey protein concentrate, a stabilizer like carrageenan, and an aerosol propellant like nitrous oxide. When dispensed, this embodiment produces protein foam that resembles traditional milk foam in consistency, color, taste and appearance.

The propellant acts as an expanding agent, agitating the emulsion into a protein foam that binds the water and other ingredients present. The stabilizer strengthens the foam produced by this aerosol milk foam method and further adds to the longevity of the bubble structure. Sweeteners and flavorings may also be added without jeopardizing the consistency or longevity of the foam produced by this aerosol milk foam method as long as they are micro-particulates and are fat free or contain very little fat. The addition of any fat destabilizes the protein foam and reduces longevity. Therefore, fat fee ingredients are optimal. Adjusting the level of protein and stabilizers will help increase foam stability in the presence of small amounts of fat (like that found in cocoa), though the resulting milk foam will experience changes in texture and taste eventually becoming unpalatable. Vegetable based milk substitutes and vegetable proteins can be substituted for fat free milk and milk protein, though the product will not be as similar to traditional milk foam.

Milk foam is not whipped cream. Some but not all of the differences between milk foam and whipped cream are as follows:

1. Milk foam is protein-based while whipped cream has a fat based bubble structure.

2. Milk foam's texture must be light and airy as opposed to whipped cream's thick, creamy and comparatively heavy texture.

3. Milk foam, as created by the aerosol milk foam method described herein, is stored under refrigeration and must be heated by microwave to mimic steam-processed milk foam, while aerosol whipped cream is served cold and melts or separates when heated.

4. Milk foam is low in fat and calories, while aerosol whipped cream is very high in fat and calories.

5. The presence of fat destabilizes protein foam and renders it into a liquid state very quickly. The emulsion described by this aerosol milk foam method must be fat free or contain very little fat. In this way, the product of the aerosol method for creating milk foam and aerosol whipped cream are very different.

In order to create a milk (cappuccino) foam similar to that traditionally served in coffeehouses, the product of the aerosol milk foam method must be room temperature or slightly warm. Since the ingredients include dairy and must be refrigerated, the ability to heat the milk foam produced by the aerosol milk foam method is essential. One characteristic that is critical and separates this aerosol milk foam method from aerosol whipped cream or other fat based foams, is that when microwaved for the appropriate time (15 to 20 seconds), the product of this aerosol milk foam method warms without separating or diminishing significantly. When warmed, the air contained within the product of the aerosol milk foam method expands which, in part, contributes to the milk foam's airy texture. If a microwave is not available, the product of this aerosol milk foam method can be folded into the coffee and warmed thusly.

It is important to reiterate that the ability to heat the product of this aerosol milk foam method is a significant departure from aerosolized whipped cream and is a key component of its novelty.

Milk (cappuccino) foams vary in consistency (wet to dry) from coffeehouse to coffeehouse and even from maker to maker. Consumer preferences therefore also differ significantly. For this reason, some variability in the overrun percentage (expansion volume; e.g., 300 is three times the volume of the emulsion prior to expansion) of milk foam is not critical as all consumers can't be pleased at any given time. We've found that an overrun percentage of about 350 is acceptable to most consumers, though an acceptable overrun range would be from 100 to 400 approximately.

The following is a description of this aerosol milk foam method in it's preferred embodiment:

Skim milk, whey protein concentrate, carrageenan are combined by weight in the following percentages respectively, 97.519%, 2.45%, 0.031%. Once mixed and pasteurized, the emulsion is filled into a common aerosol whipped cream can using equipment and techniques regularly used to fill aerosol whipped cream cans. Approximately 8 grams of nitrous oxide are added per 400 grams of emulsion as a whipping/expansion agent and propellant.

The product of said process is then refrigerated and ready for use. To use appropriately, the contents of the can are dispensed in a circular pattern covering coffee or espresso. As discussed earlier, heating the aerosol milk foam can be accomplished by microwaving the cup after foam has been added to the coffee for 15 to 20 seconds (until room temperature or slightly warm).

For purposes of evaluating this process, it is important to note that there is a significant difference between whipped cream and cappuccino foam. First, the texture of whipped cream is heavier and creamier than cappuccino foam as a result of the high concentration of fat or fat substitutes. Second, whipped cream is very high in calories whereas milk foam in this preferred embodiment is fat free and very low in calories. Third, whipped cream is served cold and cannot be served warm as the coolness promotes and maintains the coagulation of the fat which helps retain its firm shape. In contrast, cappuccino foam is traditionally served warm and, in this preferred embodiment, can be heated without diminishing its appeal or performance materially.

Drawings have not been included since the aerosol delivery system as described herein is well known to those familiar with the art of aerosol food processing.

1. A method of producing milk foam without steam, comprising the steps of:
(a) Producing an emulsion by combining water or milk (fat free or low fat), soluble animal or vegetable proteins and food stabilizers like hydrocolloids.
(b) Using equipment and processes available to those familiar with the art of aerosol processing, fill said emulsion—with a propellant/expansion agent like nitrous oxide—into an aerosol can typically used for the manufacture of aerosol whipped cream and seal with a valve typically used for dispensing aerosol whipped cream.
Whereby said emulsion, once dispensed from the aerosol delivery system, may be warmed by microwave to closely resemble steam-processed milk foam without material loss of volume, or separation of component elements or ingredients.
Whereby said method converts more than ninety percent of the emulsion contained in the aerosol delivery system into milk foam.
Whereby said method produces milk foam much more quickly and conveniently than convention methods of creating milk foam.
